(19) United States
(12) Patent Application Publication
(10) Pub. No.: US 2009/0229033 A1
(43) Pub. Date: Sep. 17, 2009

(54) Permanently embedded protective covering for articles of clothing

(76) Inventor: Judy Mertz, White Haven, PA (US)

Correspondence Address: SANFORD J. PILTCH, ESQ., 1132 HAMILTON STREET, SUITE 201, ALLENTOWN, PA, 18101, US

(21) Appl. No.: 12/386,947

(22) Filed: Apr. 24, 2009

Related U.S. Application Data
(63) Continuation-in-part of application No. 11/810,410, filed on Jun. 5, 2007.

(51) Int. Cl. A41D 1/00; B32B 37/04

(52) U.S. Cl. 2/69; 156/308.2

(57) ABSTRACT

The present invention involves a method for manufacturing an article of clothing with a permanently embedded protective covering over at least one predetermined portion of the clothing that can be worn by infants, children and adults. The protective covering is made from a thermoplastic material that is applied to and thermally bonds or co-mingles with the outermost fabric fibers of the clothing article creating a permanently embedded protective covering that retains the same flexibility as the underlying fabric of the clothing article. The protective covering can be positioned across the top front portion of the clothing article and extend downward to a lower portion of the front of the clothing article creating an easy to clean particle and dirt resistant covering for the clothing article.

### BACKGROUND OF THE INVENTION

The present invention relates generally to a method of manufacturing an article of clothing, and more particularly to superficially embedding a protective covering made of a thermoplastic material into the article of clothing or garment to be worn by either children or adults. The permanently embedded thermoplastic protective covering may be made from the application of a single layer (monolayer) of lead-free plastisol. The protective covering embedded into the garment of the present invention is functional, flexible and non-absorbent and can be clear or colored with a smooth or slightly textured surface.

Numerous patents disclose a variety of garments, including gloves, aprons, bibs and gowns, providing a protected region on said garments by use of a plurality of chemicals and methods. Many of these methods require complex assembly of a multi-layer protective covering. For example, U.S. Pat. No. 4,526,828 [Fogt et al.] discloses a protective material for use in garments such as gloves, leggings, sleeves, and aprons. This protective material comprises a base layer composed of textile material, an intermediate layer composed of a cut-resistant material having intermeshing strands, and an outer layer composed of solid, elastomeric material that retards penetration by liquids. The multi-step and complex process used to generate this protective covering also results in limited flexibility of the underlying garment.

U.S. Pat. No. 3,608,092 [Taranto] and U.S. Pat. No. 5,153,940 [Bergquist] both disclose a children's garment comprising a multi-layer protective bib attached to the underlying garment. The protective bib disclosed in U.S. Pat. No. 3,608,092 [Taranto] is composed of at least two layers of material superimposed upon one another. One layer comprises synthetic plastic sheet material overlying the front side of the garment portion, and this layer is bonded to a second layer constituting a padding material of foam or fibrous silver. Additionally, this disclosure provides for a decorative picture on the outer layer of the bib region. U.S. Pat. No. 5,153,940 [Bergquist] discloses a children's sleeper garment with an attached bib comprising two layers of protective materials. One layer is a moisture impervious layer, and it is attached to a moisture absorbent layer.

Several Patents disclose elastomer coated garments, whereby the preferred embodiments of the inventions result in a “wrinkled”, “textured” or “rough” outer layer of the garment. For example, U.S. Pat. No. 4,174,542 [Vistins] discloses an elastomer coated textile apron characterized by a textured or “wrinkle” finish. This disclosure focuses on the method of manufacturing these garments to produce a “wrinkle” finish. The garment is either dipped in or sprayed with the elastomeric resin resulting in a ‘saturated’ underlying garment with a “wrinkled” finish. Another example of elastomer coated garments with a “textured” surface is disclosed in U.S. Pat. No. 4,359,783 [Andrews]. The methods disclosed include joining a non-woven fibrous web, such as needled felt to a knitted web, and utilizing a needled staple fiber preferably from the non-woven web to join the two webs together into a formed laminate. The joining procedure is such that the finished laminate includes the needled staple fiber extending form one surface of the web to form a base surface for a subsequent application of an elastomeric coating. The methods described in the aforementioned patents provide for a “textured” protective coating on the desired garments at the cost of significantly limiting the flexibility of the underlying garment.

U.S. Patent Application Publication US2004/0123367A1 [Schorr et al.] discloses a structure developed to reduce the likelihood that low surface tension liquids, such as blood, will wick along the outside surfaces of a non-woven material. Such a structure includes a non-woven garment that is treated to include a continuous line, band or path of low surface tension liquid blocking material deposited at least along an outside surface potion of a sleeve, waist, leg, or neck opening of a body garment. The structure is placed on a garment that goes on/or around the body extremities, such as on an ankle portion of a boot, hood portion of a protective outerwear, side edges of facemasks, or wrist portions of hand coverings. The disclosure describes the manufacture of said structure from a breathable multi-layer “film”.

Other patents have described protective coverings resembling aprons for adults, which are put on over the user's clothing to protect the clothing. For example, U.S. Pat. No. 3,984,876 [Sutton] discloses a blouse cover, which fastens to the user's body and has a detachable and replaceable bib fastened to the blouse cover. Thus, a need exists for a permanently embedded protective covering that co-mingles with the fibers of a garment, and one that will not detach from the garment.

The present invention can be clearly distinguished from the aforementioned disclosures, and consequently occupies a niche that fulfills an unmet need in the field. It satisfies a need for a permanently embedded protective covering that does not consist of multiple layers, and maintains the flexible characteristics of the underlying garment. Moreover, the present invention does not have to be attached over, or temporarily to the underlying garment. Specifically, unlike the disclosures outlined in U.S. Pat. No. 4,526,828 [Fogt et al.], U.S. Pat. No. 3,608,092 [Taranto], U.S. Pat. No. 5,153,940 [Bergquist], and U.S. Patent Application Publication US2004/0123367A1 [Schorr et al.], the present invention provides for a simple method to manufacture a superficially and permanently embedded protective coating comprising only a monolayer deposited on the outer fibers of the underlying garment. There are several benefits to this invention when compared to the prior disclosures. Importantly, the inner portion of the region of the garment corresponding to the protective coating (portion in contact with the wearer) will maintain the characteristics of the underlying garment. This will maintain the inherent flexibility and comfort of the underlying garment. Another benefit of this method is that it is easier and more cost effective to embed the protective coating superficially in the form of a monolayer. Additionally, unlike U.S. Pat. No. 4,174,542 [Vistins] and U.S. Pat. No. 4,359,783 [Andrews] that disclose a “texture” or “wrinkled” finish, which can limit flexibility, the present invention puts forth an embodiment having a smooth outer surface of the coating that can maintain the desired flexibility. The current invention can also be distinguished from U.S. Patent Application Publication US2004/0123367A1 [Schorr et al.] that discloses a protective structure circumscribing the wrists, ankles and neck region of the body. In contrast, the present invention discloses a method of superficially and permanently embedding a monolayer of a protective coating on multiple regions of a plurality of garments, including bibs, gowns, overalls, ties, blouses, t-shirts, and children's sleepers.

The permanently embedded protective covering utilized in this invention may be made from the application of a single layer (monolayer) of lead-free plastisol. Plastisol is a polyvinyl chloride (PVC) or liquid vinyl dispersion or thermoplastic, which is fused by heating to form a solidified end product. The plastisol will fuse rapidly to the fabric of a garment because of its fine particle structure. The temperature at which plastisol cures and, by such curing process, is impregnated (or partially impregnated) into a fabric material ranges ideally between 150° F. to 200° F., but can increase up to 330° F.

The plastisol is embedded into the fabric by the use of a process for applying the plastisol material at a temperature sufficient to change the state of the material to a liquid and at higher pressures, such that in combination the liquid plastisol is forced between the fibers of the material of the fabric to which it is being applied. The process then immediately requires a cool-down of the plastisol before it penetrates through all the layers of the fabric. The cooling process ensures that the plastisol embeds only within the outermost garment fibers, interweaving with the fibers of the garment where it remains. In this fashion the plastisol material will not penetrate through all of the layers of the fabric, avoiding direct contact with the skin of the user. Alternatively a heat transfer may be made by screen-printing plastisol on a special release paper. The “transfer” is then applied to a garment or fabric using a heat press that applies pressure and melts the material so it will bond with the fabric, as it is pressed into the garment fibers by the heat press. The heat applied by the heat press liquefies the plastisol material so that it can penetrate the upper layers of the fabric and, once the heat source is removed, the plastisol cures or hardens around the garment fibers.

The plastisol material is self-extinguishing, non-toxic and water resistant. Plastisol has a good natural bond to most porous surfaces such as paper, fabrics, pile, rope or any material that will allow some superficial penetration by the plastisol material. Since plastisol is a thermoplastic, some softening occurs above room temperature, however it can withstand exposure to temperatures of 180° F. without actual deterioration. Plastisol will not decompose or change significantly in acids, alkalines, detergents, foodstuffs, water or other natural substances. The permanently embedded protective covering does not hold or retain substances very easily. The protective covering is non-absorbent with a smooth or slightly textured surface so that if a particular substance holds temporarily it can easily be wiped away with soap and water.

The present invention provides a permanently embedded protective covering that can be used on garments for both adults and children, which covering does not require fastening means, and which provides protection to the overall garment. The present invention does not have to be worn over a garment, because it already exists on the garment as it is embedded into and co-mingles with the fibers of the garment giving the protective covering the same flexibility as the garment. The present invention is non-toxic and flame retardant, and as easy to clean as the garment itself.

### SUMMARY OF THE INVENTION

The present invention provides a method for manufacturing an article of clothing with a permanently embedded protective covering directly set or embedded into the fibers of the garment. The permanently and superficially embedded protective covering is made from a plastisol, which is embedded into the fabric by the use of a combination of high temperature and high pressure, and then immediately cooled before the plastisol material can penetrate through all of the layers of the fabric. The cooling process ensures that the plastisol co-mingles only within the top garment fibers and interweaves with the fabric fibers of the garment, where it remains, so that it will not penetrate through all the layers of the fabric, avoiding direct contact with the skin of the user. The plastisol will thermally bond to the underlying fabric of the garment in a temperature range between 150° F. to 200° F. ideally, however the temperature may be increased as high as 330° F.

The permanently embedded protective covering preferably covers the top portion of the garment and extends downward to the mid torso. However, the protective covering can be placed across or extended over a lower portion of the garment, if the lower portion of the garment is prone to attracting particles and dirt. The permanently embedded protective covering surrounds the underlying fiber layers of the fabric so that it becomes one with the fabric and attains the same flexibility as the fabric of the garment, thereby making it a solid portion that cannot be broken easily.

The garment, in one preferred embodiment, can be an infant's sleeper or shirt, preferably of a soft woven material. The permanently embedded protective covering begins at the top or neckline of the sleeper or shirt and extends to approximately the mid torso. A different embodiment of the invention can be on a young child's shirt. The permanently embedded protective covering could begin at the neck portion of the shirt and extend to approximately the mid torso.

Yet another embodiment is envisioned to be a permanently embedded protective covering on an adult sized shirt, gown or coat for use in a hospital, nursing home, restaurant, or other institution or facility where clothing would be getting fluids or foods on them and need to be easily wiped away or cleaned. A permanently embedded protective covering in accordance with the present invention would be particularly useful and convenient as it is easy to clean, non-toxic and flame retardant.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 is a front view of an infant's jumper with the permanent protective covering of the present invention extending from the neckline to approximately the mid torso portion of intended wearer.

FIG. 2 is a front view of a child's shirt with the permanent protective covering of the present invention extending over the upper torso area of intended wearer.

FIG. 3 is a front view of an adult shirt-like garment with the permanent protective covering of the present invention extending from the neckline to approximately the lower torso area of intended wearer.

FIG. 4 is a partial sectional view of the permanent protective covering of the present invention embedded through the outer layer of the fabric and under the cross-weave fibers of an article of clothing.

FIG. 5 is a front view of an infant's sleeper with the permanent protective covering of the present. invention extending from the neck to approximately the lower torso portion of intended wearer.

FIG. 6 is a front view of an adult's work overalls with the permanent protective covering of the present invention extending from the top of the overalls to the waist portion of intended wearer.

FIG. 7 is a front view of an adult healthcare worker's uniform shirt with the permanent protective covering of the present invention extending from the neckline to approximately the lower torso portion of intended wearer.

FIG. 8 is a front view of a dress with the permanent protective covering of the present invention extending from the neckline to approximately the waist of the wearer.

FIG. 9 is of a perspective view of a man's tie with the permanent protective coating of the present invention extending almost the entire length of the outer surface of the tie.

FIG. 10 is a front view of a patient gown with the permanent protective coating of the present invention extending from the neckline to approximately the lower torso of the intended wearer.

FIG. 11 is a front view of a medical practitioner's gown with the permanent protective coating of the present invention extending from the neckline to approximately the lower torso of the intended wearer and along the distal areas of the sleeves.

### DETAILED DESCRIPTION OF THE PREFERRED EMBODIMENT

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

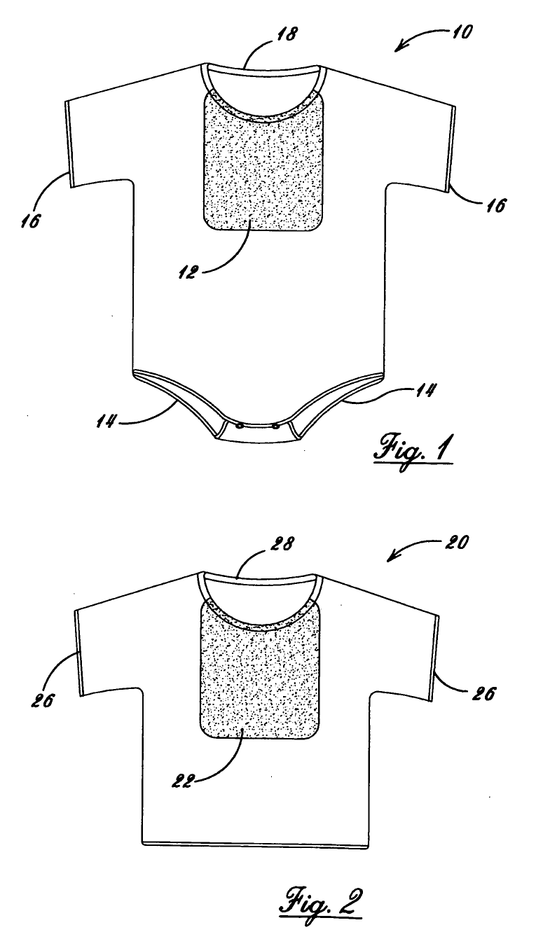

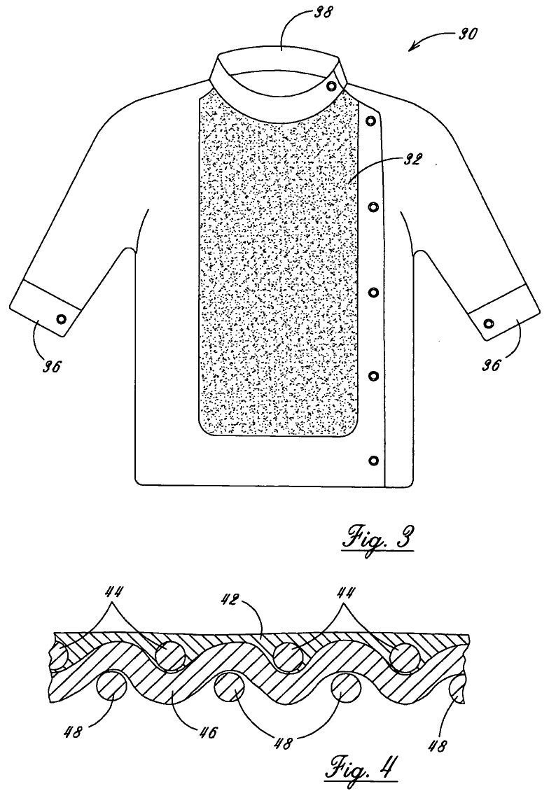

Referring now to the drawings in detail, where like numerals refer to like parts or elements, there are shown in FIGS. 1-3 and 5-11 a number of different articles of clothing for a variety of differently sized persons. However, before describing each of the varying sized articles of clothing carrying the protective covering, the method of manufacturing the specialized article of clothing with the impermeable protective covering of the present invention is best described in connection with FIG. 4.

FIG. 4 is a partial sectional view of the article of clothing showing the thermoplastic material 42 used for creating the permanent protective covering interweaved with the fabric fibers of the garment 44, 46. The thermoplastic material of the permanent protective covering 42 of the present invention is applied to and impregnated or embedded into the fibers of the fabric of the garment. This process results in an interweaving of the thermoplastic material through the outermost layer of fibers 42 of the fabric of the garment. The thermoplastic material is applied in a fluid state so that the material will flow in and around the fibers of the fabric of the garment such as the individual fibers 44 and the cross-weave fibers 46 of the garment shown in FIG. 4. This creating of the protective covering into the desired areas of the various garments is accomplished in the following manner.

The protective covering 42 is preferred to be of a thermoplastic material, such as plastisol ink, which is considerably thicker than most graphic inks. The plastisol material will fuse rapidly into the garment fibers 44, 46 due to its fine particle structure. The temperature at which the plastisol material will attain a fluid state so that it will flow into the fabric of the garment is in the range of 150° F. to 200° F., but the temperature may be increased up to 330° F. The plastisol material is embedded into and between the fibers of the fabric by the use of a combination of the higher temperature and a high-pressure application. Once applied and following a time period sufficient for dispersion through the outer layer of the fabric of the garment and into an intermediate layer of the fabric, the thermoplastic material and the garment are cooled before the thermoplastic material can flow into and through all the layers of the fabric. The cooling process ensures that the plastisol material penetrates and embeds only within the outermost fabric fibers of the garment by flowing under and through the outer fibers 44 and under the cross-weave fibers 46. When cooled below the threshold temperature of 150° F., the plastisol material remains within the outer layers of fiber of the garment. In this manner, the thermoplastic material does not penetrate through all the layers of the fabric, direct contact with the skin of the user is avoided.

Alternatively, a heat transfer may be made by screen-printing plastisol ink on a special release paper. The “transfer” is then applied to the garment using a heat press that applies pressure and changes the state of the plastisol ink from solid to fluid so that it will flow and bond with the fibers of the garment, as its pressed into the garment fibers 44 and cross-weave fibers 46 by the heat press. The heat applied by the heat press is maintained for a time period sufficient for the plastisol ink to liquefy and flow into and around the outer fibers 44, 46 of the fabric of the garment and is then removed to allow the plastisol material to cure by forming a permanent bond with the fabric fibers 44, 46. The permanently embedded protective covering 42 can be seen to entirely surround the outermost layer of the fabric, which consist of the individual fibers 44, and be seen to impregnate the individual cross-weave fibers 46, so that protective covering becomes one with the fabric and attains the same flexibility as the fabric of the garment.

Referring now to FIG. 1, there is shown a garment 10 for an infant with leg openings 14, arm openings 16 and a neck opening 18. The garment 10 has a permanently embedded protective covering 12 thermally applied, as described above, directly onto the garment 10, beginning with the neck opening 18 of the garment and extending downward to approximately the mid torso area. Other areas, or an extension of the protected area shown, may also have the protective covering 12 added over and into the fabric of the garment 10. The garment 10 can be made from various materials, but is preferably made of a soft woven fabric. The protective covering 12 is moisture impervious, non-toxic and flame retardant, and may hold debris temporarily, which can be easily wiped away with soap and water. The protective covering 12 is preferably opaque and can be a variety of colors, however, it may also be colorless in which case it would be translucent permitting the coloring of the garment to pass through.

Referring to FIG. 2, there is illustrated a t-shirt style garment 20 for a small child or infant with arm openings 26 and a neck opening 28. The garment 20 has a protective covering 22 beginning at the neck opening 28 of the garment 20 and extending downward to approximately the mid torso area. The garment 20 has a permanently embedded protective covering 22 thermally applied, as described above, directly onto the garment 20, beginning with the neck opening 28 of the garment and extending downward to approximately the mid torso area. Other areas, or an extension of the protected area shown, may also have the protective covering 22 added over and into the fabric of the garment 20.

In FIG. 3 there is shown a garment 30 for an adult that may be used as a chefs coat, smock or shirt, or be used by a healthcare professional. The garment 30 has a neck opening 38, arm openings 36 and a protective covering 32. The protective covering 32 begins at the neckline and extends downward ending approximately at the lower torso area. The garment 30 has a permanently embedded protective covering 32 thermally applied, as described above, directly onto the garment 30, beginning with the neck opening 38 of the garment and extending downward to approximately the mid torso area. Other areas such as the sleeves of the over blouse 30, or an extension of the protected area shown, may also have the protective covering 32 added over and into the fabric of the garment 30.

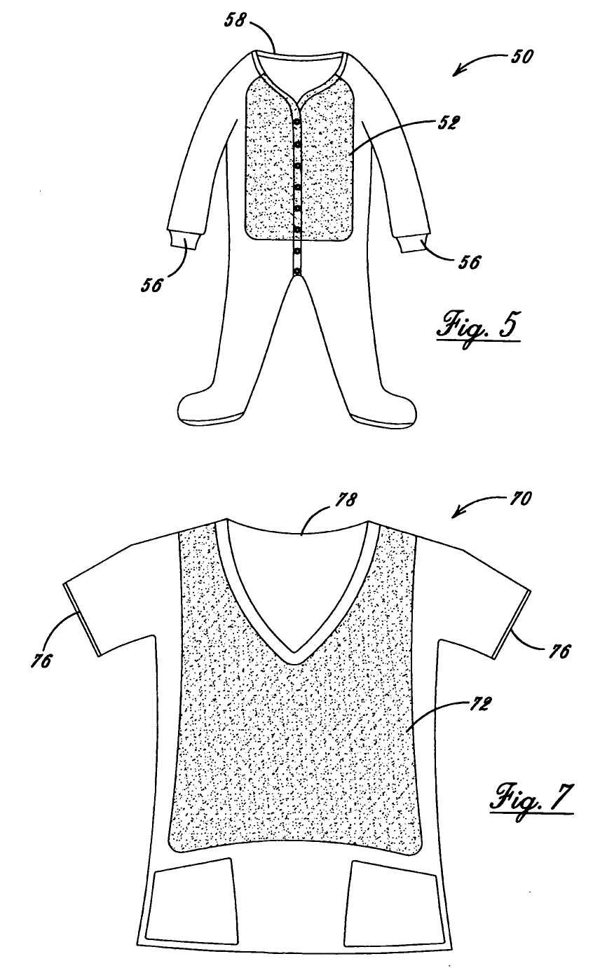

Another garment utilizing the protective covering of the invention is illustrated in FIG. 5 showing a garment 50 in the style of an infant's sleeper, with a permanently embedded protective covering 52, a neck opening 58, and a pair of arm openings 56. The protective covering 52 is shown beginning at the neck opening 58 and extending downward to and ending approximately at the lower torso area. As with the other types of garments, garment 50 has a permanently embedded protective covering 52 thermally applied, in accord with the method described above, directly onto the garment 50, beginning with the neck opening 58 of the garment and extending downward to and ending approximately at the lower torso area. Also, as above, other areas, or an extension of the protected area shown, may also have the protective covering 52 added over and into the fabric of the garment 50.

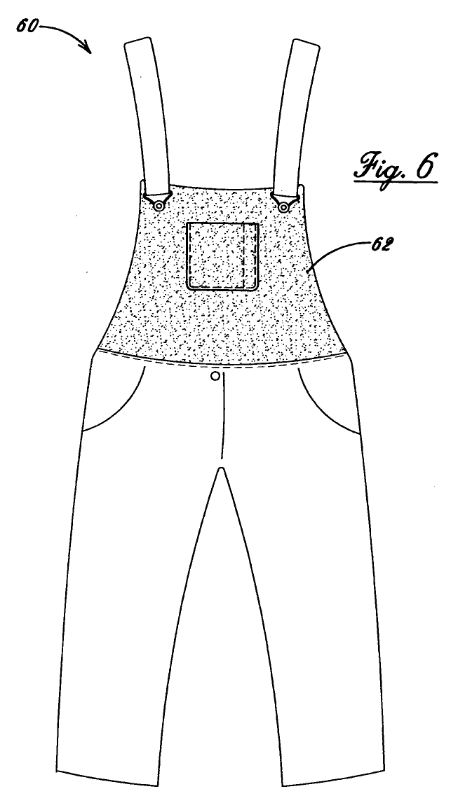

Another garment is illustrated in FIG. 6 that shows a different type of clothing. The article of clothing 60 is in the form of a child's overalls, or may be an adult worker's overalls, with a permanently embedded protective covering 62. The protective covering 62 extends from the top of the bib portion of the overalls downward to approximately the waist portion of the garment 60. As in the case of the other articles of clothing, garment 60 has a permanently embedded protective covering 62 thermally applied, in accord with the method described above, directly onto the garment 60. Also as above, other areas, or an extension of the protected area shown, may have the protective covering 62 added over and into the fabric of the garment 60.

Another article of clothing utilizing the method of the present invention, as illustrated in FIG. 7, shows a garment 70 in the form of an adult healthcare worker's uniform shirt or smock with a permanently embedded protective covering 72, a neck opening 78, and a pair of arm openings 76. The protective covering 72 extends from the seams joining the front and back sides at top of the garment 70 downward around neck opening 78 and farther downward to end approximately at the lower torso area.

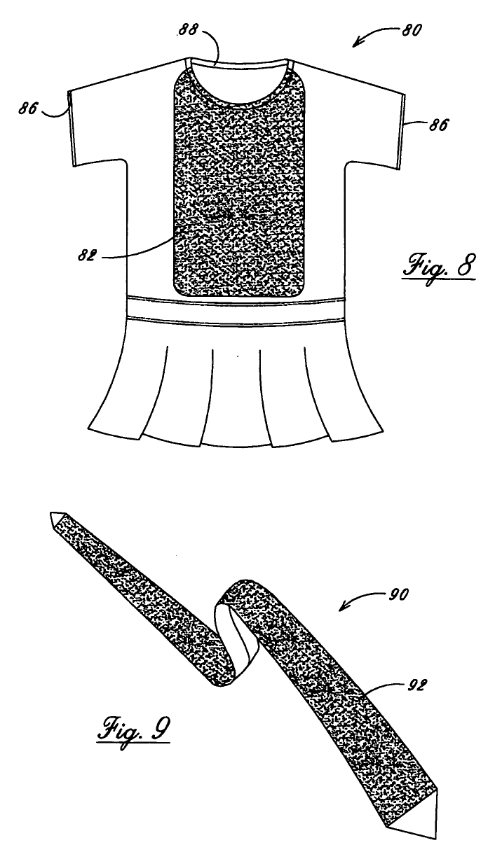

FIG. 8 illustrates a garment 80 in the form of a dress with a permanently embedded protective coating 82, a neck opening 88, and arm openings 86. The protective covering 82 extends from the top portion of the dress downward to approximately the waist portion of the garment 80. As in the case of the other articles of clothing, garment 80 has a permanently embedded protective covering 82 thermally applied, in accord with the method described above, directly onto the garment 80. Also as above, other areas, or an extension of the protected area shown, may have the protective covering 82 added over and into the fabric of the garment 80.

A garment 90 shown in FIG. 9 is a man's tie with a permanently embedded protective coating 92. The protective covering 92 extends from the top portion of the tie downward over the outer surface of the tie to the bottom portion of the garment 90. As in the case of the other articles of clothing, garment 90 has a permanently embedded protective covering 92 thermally applied, as described above, directly onto the garment 90. Also as above, it can be envisioned that different areas of the tie may have the protective covering 92 added over and into the fabric of the garment 90.

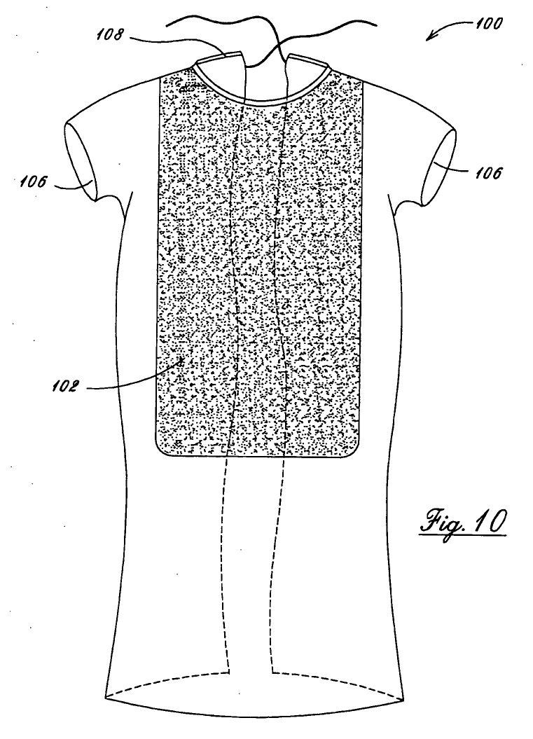

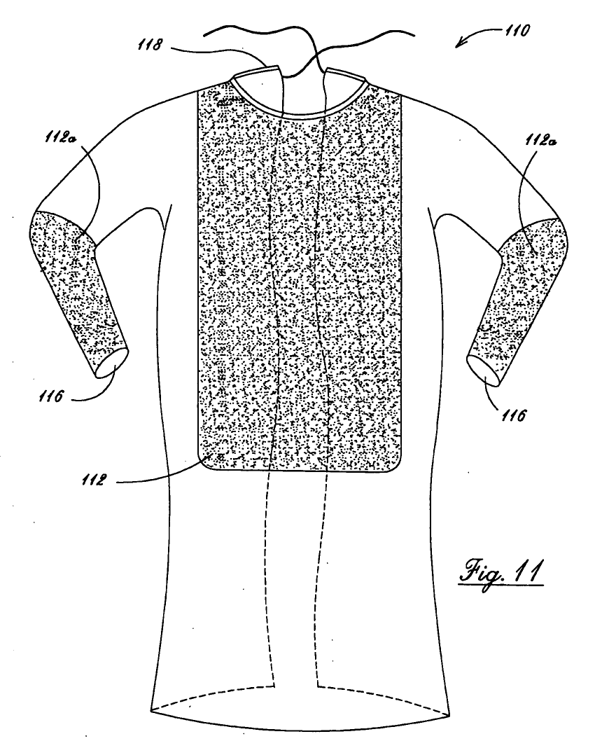

FIG. 10 illustrates another garment 100 depicting a patient gown with a permanently embedded protective coating 102, a neck opening 108, and a pair of arm openings 106. The protective covering 102 extends from the top of the neck portion of the gown downward to below the waist portion of the garment 102. As in the case of the other articles of clothing, garment 100 has a permanently embedded protective covering 102 thermally applied, in accord with the method described above, directly onto the garment 102. Also as above, other areas, or an extension of the protected area shown, may have the protective covering 102 added over and into the fabric of the garment 100.

Garment 110, as illustrated in FIG. 11, is a medical practitioner's gown showing the permanently embedded protective coating 112, a neck opening 118, and a pair of arm openings 116. As depicted in FIG. 11, the protective coating 112 is applied, according to the methods described above, to multiple regions of the medical practitioner's gown. Specifically, the protective coating 112 extends from the neck portion of said gown downward to below the waste portion of garment 110. Additionally, the protective coating 112a is also applied to the arm portions of garment 110; extending from the wrist region of said gown upwards above the elbow portion of garment 110. Also as above, other areas, or an extension of the protected areas shown, may have the protective covering 112, 112a added over and into the fabric of the garment 110.

As in the cases of the previously described garments, the protective coverings 12, 22, 32, 52, 62, 72, 82, 92, 102, and 112 are each positioned to extend over and protect that area or portion of the garment or article of clothing that is most likely to be spilled on, or to receive splatter or some other form of deposit of a foodstuff, or the deposit of a human bodily fluid that would normally dampen, in the case of infant saliva, or create an area of contact with the garment leaving on the garment some form of material that has splattered or spilled during eating or using the garment during the course of regular workplace routine. In each case the protective covering allows the easy wiping away of the majority of the spillage or spatter, and then the easier washing of the article of clothing to remove the remainder of the deposit.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A method of manufacturing an article of clothing having an impermeable protective covering permanently embedded into a portion of the article of clothing comprising the steps of:
providing an article of clothing to be worn by an infant, child or adult, said article of clothing having exterior and interior surfaces;
applying a thermoplastic material to at least one predetermined area of the exterior of the article of clothing at increased temperature and pressure for a period of time sufficient for the thermoplastic to penetrate only into the outermost fibers of the fabric of the article of clothing;
cooling the thermoplastic material immediately following said period of time to create a permanent impermeable protective covering embedded into and interweaved with the outer fibers of the predetermined area of said article of clothing without penetrating to the interior surface thereof, said protective covering retaining the flexibility of the underlying article of clothing.

2. The method of claim 1, wherein the at least one predetermined area of the article of clothing for embedding the protective covering is selected from the group consisting of the upper front portion, the upper and mid front portions, the lower arm portions, and the lower and mid arm portions.

3. The method of claim 1, wherein said permanently embedded protective covering is non-toxic, moisture impervious, and flame retardant.

4. The method of claim 1, wherein the thermoplastic material may be a plastisol ink.

5. The method of claim 1, wherein the thermoplastic material may have color, translucency, or be substantially transparent.

6. The method of claim 1, wherein said temperature to thermally bond the thermoplastic material to the underlying fabric of the article of clothing is in a range between 150° F. to 330° F.

7. The method of claim 5, wherein said temperature is preferably in a range between 150° F. to 200° F.

8. The article of clothing according to claim 1, wherein said article of clothing comprises a woven fabric.

9. The article of clothing according to claim 1, wherein said article of clothing comprises a non-woven fabric.
